(19) United States
(12) Patent Application Publication
(10) Pub. No.: US 2005/0171755 A1
(43) Pub. Date: Aug. 4, 2005

(54) System and method for executing files in a browser

(75) Inventors: Hao Du, Chongqing (CN); Mingping Xu, Chongqing (CN)

Correspondence Address: HOGAN & HARTSON L.L.P., 500 S. GRAND AVENUE, SUITE 1900, LOS ANGELES, CA, 90071-2611, US

(73) Assignee: FarStone Technology, Inc.

(21) Appl. No.: 11/021,449

(22) Filed: Dec. 22, 2004

(30) Foreign Application Priority Data
Dec. 25, 2003 (TW) 92136810

(51) Int. Cl. G06F 9/45

(52) U.S. Cl. 703/22

(57) ABSTRACT

An access system and methodology that browses files stored in a server with a browser. According to the invention, an executable file is directly executed in a browser.

### BACKGROUND OF THE INVENTION

1. Field of the Invention

The present invention relates generally to a system and method for executing files in a browser, and more particularly to a virtual CD/DVD Tower that directly executes files.

2. Description of Prior Art

A program in a Virtual CD provided by a conventional virtual CD-ROM tower can be browsed and downloaded in a browser. When the Virtual CD is downloaded into user's hard disk, the Virtual CD will occupy the storage space of the hard disk. Accordingly to the conventional virtual CD-ROM tower software, the downloaded emulated CD is often incapable of executing normally. This will make the user feel headache.

Conventional executable file can be classified into an independent executable file and a dependent executable file. The independent executable file, such as the notepad.exe, can be executed independently. And the dependent executable file, such as the mstsc.exe, can not be executed independently. The mstsc.exe can just be executed under support of the mstscax.dll file.

Generally speaking, for a game program stored in the laser disc, the game program is an executable file that depends on support of several files. So, the laser disc also provides such files in addition to the executable file (.EXE ). The user must also download all depending files. However, for a game player, constant downloading the materials from the browser is very convoluted work, often make the user feel tired.

For example, the conventional virtual CD-ROM tower software, such as the Disc Zerver software developed by Microtest Corporation, includes a program to browse and download the emulated CD image file provided by the virtual CD-ROM tower in a browser.

The Disc Zerver software is installed in a server. The Disc Zerver software includes a storage subsystem, a controlling unit and an operating system kernel. The controlling unit creates a emulated CD with selected files from a CD or hard drive. The emulated CD is sent to the LAN or the Internet. The storage subsystem stores the emulated CDs. The operating system kernel is a Linux operating system kernel. Though the user may browse and download the executable file (.EXE) provided by a conventional virtual CD-ROM tower software, presently available virtual CD-ROM tower software products either have the problems of being unable to execute an executable file in a browser directly or have the problems of manipulating the data conveniently.

### SUMMARY OF THE INVENTION

The present invention provides a virtual CD/DVD Tower system and method to resolve the foregoing problems faced by the conventional virtual CD-ROM tower software. The present invention also has the advantage of executing an executable file directly in a browser.

An object of the present invention is to provide a virtual CD/DVD Tower system and method, wherein a client package can be stored in the virtual CD/DVD Tower system. The user can execute an executable file directly in a browser.

Another object of the present invention is to provide a virtual CD/DVD Tower system and method, which can automatically load the emulated CD into a CD Emulator for executing. The emulated CD stores the executable file selected in a browser, which can be executed without referring to other files.

In accordance with an aspect of the present invention, an access system is used for executing an executable file in a browser. The access system includes a processing unit for installing a processing module and generating a simulating module, wherein said processing module loads said executable file, and said simulating module executes a simulating operation, said executable file being executed without download operation beforehand.

In the preferred embodiment of the invention, the executable file is stored in an emulated CD. The processing module loads the emulated CD into the simulating module for executing. The simulating module simulates a CD-ROM. the processing module downloads from the Internet. The processing module comprises a mounting/rejecting module and a driver for a CD-ROM emulator.

In accordance with another aspect of the present invention, another access system is used for executing an executable file in a browser. The access system includes an installing unit for installing a processing module; and a simulating module for executing the executable file loaded by the processing module.

In the preferred embodiment of the invention, the executable file is stored in an emulated CD. The processing module loads the emulated CD into the simulating module for executing. The simulating module simulates a CD-ROM. the processing module downloads from the Internet. The processing module comprises a mounting/rejecting module.

In accordance with a further aspect of the present invention, a method for directly executing a file in a browser is suitable for a computer system. The computer system has an access system. The method comprising the steps of: simulating the file stored on a server and generating a simulated file; loading the simulated file into the access system; and executing the simulated file.

In the preferred embodiment of the invention, the method further comprises the step of downloading a processing module from the Internet. The method further comprises the step of installing the processing module. The method further comprises the step of generating a simulating module for simulating the file stored on the server.

The present invention may best be understood through the following description with reference to the accompanying drawings, in which:

### BRIEF DESCRIPTION OF THE DRAWINGS

FIG. 1 shows a schematic block diagram of a virtual CD/DVD Tower system of a preferred embodiment according to the present invention.

FIG. 2 shows a schematic flow chart of a method for executing files in a browser of the preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new executing technique to access files in a browse. Users can access the Virtual CD/DVD Tower through a web browser and the client side tool. The administrator can maintain Virtual CD/DVD Tower through a web browser. The administrator can even manage the Virtual CD/DVD Tower remotely via the Internet, which makes the maintenance a breeze.

With the Virtual CD/DVD Tower of the present invention, Virtual CD/DVD Tower allows administrators to create an image of a CD on the server hard drive. The Virtual CD/DVD Tower incorporates a high-performance compression engine for building VCD files (ripping at 50% compression rate).

Up to 5,000 users can be added to Virtual CD/DVD Tower and multiple users can access a VCD simultaneously. Network configuration allows users to configure Web server, SMB Server, NFS Server, etc. Using the Live Update function, users can get the latest updates and patches for Virtual CD/DVD Tower from the Internet. Save your current Virtual CD/DVD Tower configuration file and apply it at any time. According to the preferred embodiment of the present invention, an access system is used for executing an executable file in a browser. The access system includes a processing unit for installing a processing module and generating a simulating module, wherein said processing module loads said executable file, and said simulating module executes a simulating operation, said executable file being executed without download operation beforehand.

The executable file is stored in an emulated CD. The processing module loads the emulated CD into the simulating module for executing. The simulating module simulates a CD-ROM. the processing module downloads from the Internet. The processing module comprises a mounting/rejecting module and a driver for a CD-ROM emulator.

According to the preferred embodiment of the present invention, another access system is used for executing an executable file in a browser. The access system includes an installing unit for installing a processing module; and a simulating module for executing the executable file loaded by the processing module.

The executable file is stored in an emulated CD. The processing module loads the emulated CD into the simulating module for executing. The simulating module simulates a CD-ROM. the processing module downloads from the Internet. The processing module comprises a mounting/rejecting module.

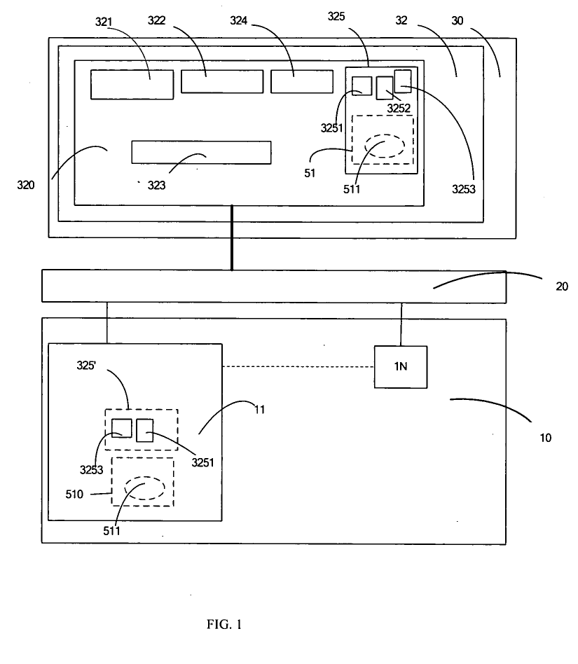

Referring to FIG. 1, a schematic block diagram of a virtual CD/DVD Tower system of a preferred embodiment according to the present invention is shown. The virtual CD/DVD Tower system of the present invention is suitable for a computer system. The virtual CD/DVD Tower is ideal for situations where CD-ROM information needs to be accessed by multiple users quickly and conveniently.

The computer system includes a client end 10 and a server end 30. Computers 11-1N at the client end 10 are connected to a server 32 at the server end 30 over a LAN or the Internet 20.

The server 32 installs an access system 320. The access system 320 is used for executing an executable file in a browser. The executable file is stored in an emulated CD 511. The access system 320 includes a storage subsystem 321, a controlling unit 322, an operating system kernel 323, a detecting unit 324 and a processing unit 325. The controlling unit 322 is used for creating an emulated CD. The emulated CD is created with selected files from a CD or hard drive. The emulated CD is sent to the browser at the client computer via the LAN or the Internet 20. The storage subsystem 321 is used for storing the emulated CDs. The executable file is stored in the emulated CD. The operating system kernel 323 may be a Linux operating system kernel.

The detecting unit 324 is used for detecting whether a simulating module 510 is installed in the client computer 10. If the simulating module is not installed in the client computer 10, then downloads and installs a processing unit 325 via the Internet to create a simulating module 510 in the client computer 10. If the CD emulator is installed in the client computer 10, then downloads and installs a processing module 325′ via the Internet to create a simulating module 510 in the client computer 10.

The processing unit 325 is used for installing the processing module in the client computer 10. The processing unit 325 comprises a judging module 3251, a mounting/rejecting module 3253 and a driver for a CD-ROM emulator 3252. The judging module 3251 is used for judging whether the link on the webpage selected in the browser is an executable file. The mounting/rejecting module 3253 is used for mounting/rejecting the emulated CD 511 into/from the simulating module 51. The simulating module 51 is used for executing the executable file. The simulating module 51 simulates a CD-ROM. The driver for a CD-ROM emulator 3252 is used for creating the simulating module 51.

The client computer 11 installs an access system. The access system is used for executing an executable file in a browser. The executable file is stored in an emulated CD 511. The access system includes an installing unit for installing a processing unit 325. The processing unit 325 downloads from the Internet. The processing unit 325 loads the emulated CD 511 into the simulating module 510 for executing. The executable file is loaded, and the simulating module 510 executes a simulating operation.

The processing unit 325 comprises a judging module 3251, a mounting/rejecting module 3253 and a driver for a CD-ROM emulator 3252. The judging module 3251 is used for judging whether the link on the webpage selected in the browser is an executable file. The mounting/rejecting module 3253 is used for mounting/rejecting the emulated CD 511 into/from the simulating module 510. The simulating module 510 is used for executing the executable file. The simulating module 510 simulates a CD-ROM. The driver for a CD-ROM emulator 3252 is used for creating the simulating module 510.

The installing unit may install a processing module 325′ if there has been the simulating module 510 in the client computer 10. The virtual CD/DVD Tower can be accessed through a standard web browser or directly from the processing unit module 325′. The processing module 325′ downloads from the Internet. The processing module 325′ loads the emulated CD 511 into the simulating module 510 for executing. The executable file is loaded, and the simulating module 510 executes a simulating operation. The executable file can be directly executed in the browser without download operation beforehand.

The processing module 325′ comprises a judging module 3251 and a mounting/rejecting module 3253. The judging module 3251 is used for judging whether the link on the webpage selected in the browser is an executable file. The mounting/rejecting module 3253 is used for mounting/rejecting the emulated CD 511 into/from the simulating module 510. The simulating module 510 is used for executing the executable file.

According to the preferred embodiment of the present invention, a method for directly executing a file in a browser is suitable for a computer system. The computer system has an access system. The method comprising the steps of: simulating the file stored on a server and generating a simulated file; loading the simulated file into the access system; and executing the simulated file.

The method further comprises the step of downloading a processing module from the Internet. The method further comprises the step of installing the processing module. The method further comprises the step of generating a simulating module for simulating the file stored on the server.

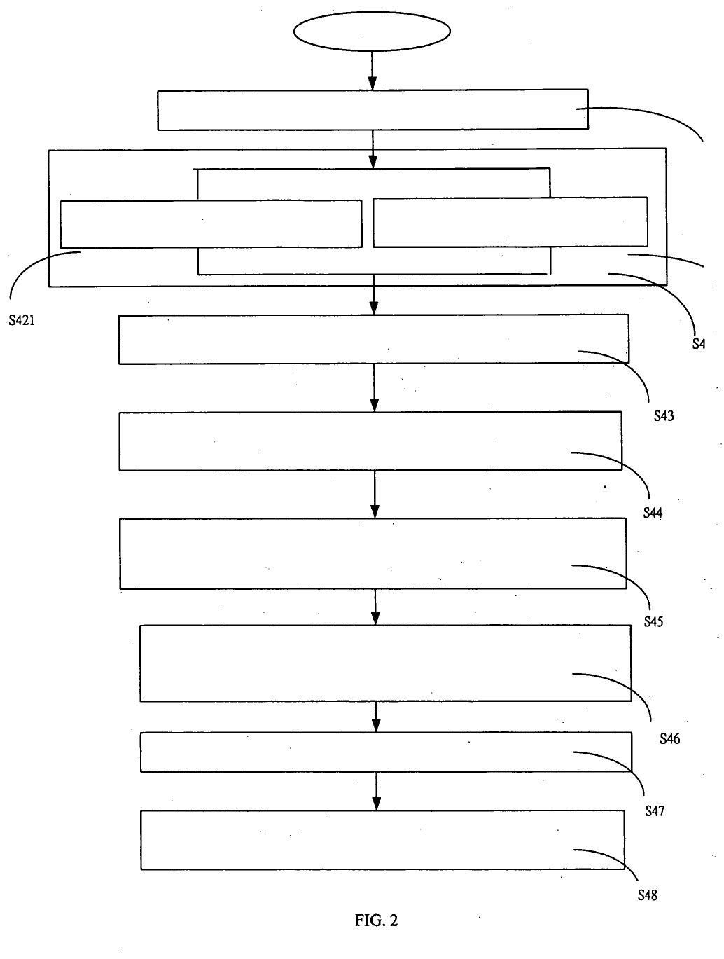

Referring to FIG. 2, a schematic flow chart of a method for executing files in a browser of the preferred embodiment according to the present invention is shown. According to the present invention, the method of the present invention is suitable for a computer system. A simulating module for simulating an executable file stored on a server of the computer system is generated. Step S41, is to detect whether a CD emulator is installed in the client computer. If yes, the CD emulator is installed in the client computer, and then goes to Step S422. If no, go to Step S421. Step S421, is to download and install a processing module from the Internet and to create a CD emulator in the client computer. Also installs a judging module 3251 and a mounting/rejecting module 3253 into the client computer. Step S422, is to install a judging module 3251 and a mounting/rejecting module 3253 into the client computer. The judging module 3251 judges the link operation on the webpage in the browser. As shown in this figure, step S43, is to select a virtual CD/DVD tower in the server. Step S44, is to access the virtual CD/DVD Tower. Step S45, is to browse the file stored in the virtual CD/DVD tower in the server.

Step S46, is to select the simulated file in the virtual CD/DVD tower. The mounting/rejecting module in the client computer loads the simulated file into the CD emulator. The simulated file can be directly executed in the browser.

The Virtual CD/DVD Tower of the present invention provides a Linux-based, stand-alone network application that emulates a CD-ROM server, allowing you to create, store and access virtual CD-ROMs across any TCP/IP network. With Virtual CD/DVD Tower, you can create an image of a CD/DVD on your Linux Server. This image is known as a Virtual CD or VCD. Virtual CD/DVD Tower supports most disc formats, including Audio CDs, CD-ROMs, Video CDs, Photo CDs, Mixed Mode CDs, DVD Videos (unprotected), DVD Data discs, and even the copy-protected CD/DVDs.

The Virtual CD/DVD Tower according to the present invention is ideal for situations where CD-ROM information needs to be accessed by multiple users quickly and conveniently over a LAN or the Internet. Virtual CD/DVD Tower can be accessed through a standard web browser or directly from the Virtual CD/DVD Tower Client software.

Furthermore, by using the Virtual CD/DVD Tower of the present invention, the CD Towers serve as containers for all virtual CDs. Users who have been granted access rights by the Administrator may enter various private Towers. Users can also create CD towers and assign access privileges of the CD tower to other users after logging in to Virtual CD/DVD Tower with an administrator account. Selecting Virtual CD/DVD Tower Device from the General list will display the detailed information about Virtual CD/DVD Tower and its folder information. Virtual CD/DVD Tower Information shows information such as the Virtual CD/DVD Tower version, manufacturer, license, etc. Saving Folder displays the Virtual CD/DVD Tower folder information as its path, SMB share name, location, size, etc. You can also create a new VCD folder or delete existing folders.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. An access system for executing an executable file in a browser, comprising: a processing unit for installing a processing module and generating a simulating module, wherein said processing module loads said executable file, and said simulating module executes a simulating operation, said executable file being executed without download operation beforehand.

2. The access system according to claim 1, wherein said executable file is stored in an emulated CD.

3. The access system according to claim 2, wherein said processing module loads said emulated CD into said simulating module for executing.

4. The access system according to claim 1, wherein said simulating module simulates a CD-ROM.

5. The access system according to claim 1, wherein said processing module downloads from the Internet.

6. The access system according to claim 1, wherein said processing module comprises a mounting/rejecting module and a driver for a CD-ROM emulator.

7. A access system for executing an executable file in a browser, comprising: an installing unit for installing a processing module; and a simulating module for executing said executable file loaded by said processing module.

8. The access system according to claim 7, wherein said executable file is stored in an emulated CD.

9. The access system according to claim 8, wherein said processing module loads said emulated CD into said simulating module for executing.

10. The access system according to claim 9, wherein said simulating module simulates a CD-ROM.

11. The access system according to claim 7, wherein said processing module downloads from the Internet.

12. The access system according to claim 7, wherein said processing module comprises a mounting/rejecting module.

13. A method for directly executing a file in a browser, which is suitable for a computer system having an access system, said method comprising the steps of: simulating said file stored on a server and generating a simulated file; loading said simulated file into said access system; and executing said simulated file.

14. The method according to claim 13, further comprising the step of downloading a processing module from the Internet.

15. The method according to claim 14, further comprising the step of installing said processing module.

16. The method according to claim 14, further comprising the step of generating a simulating module for simulating said file stored on said server
